(19) United States
(12) Patent Application Publication
(10) Pub. No.: US 2026/0368532 A1
(43) Pub. Date: Nov. 19, 2026

(54) SYNTHETIC DATA GENERATION FOR TRAINING A SMALL LANGUAGE MODEL FOR GROUNDING CHECKING

(71) Applicant: Palo Alto Networks, Inc., Santa Clara, CA (US)

(72) Inventors: Gaurav Mitesh Dalal, Fremont, CA (US); William Redington Hewlett, II, Mountain View, CA (US)

(21) Appl. No.: 19/223,230

(22) Filed: May 30, 2025

Related U.S. Application Data
(60) Provisional application No. 63/805,161, filed on May 13, 2025.

(51) Int. Cl. G06N 3/0895

(52) U.S. Cl. CPC G06N 3/0895

(57) ABSTRACT

A lightweight checking system has been created that uses a small language model (SLM) to check foundation model answers. The SLM is trained with a synthetic training dataset created to encompass variations of variables relevant to queries, responses, and contexts. A pipeline generates candidate samples based on random permutations of selections for the training sample variables. Each training sample includes a generated query, a generated context, a generated response, and a label that indicates whether the response is consistent with the generated context (“grounded”) or inconsistent with the generated context (“not grounded”). Multiple foundation models/large language models (LLMs) judge whether the generated labels are accurate for the training samples. When the judging LLMs agree with a label, the corresponding candidate sample is added to a training dataset. When the judging LLMs disagree or do not completely agree with the label, the corresponding candidate sample is discarded.

### BACKGROUND

The disclosure generally relates to generating training data to train a small language model for grounding checking (e.g., CPC subclass G06 18/214).

The Stanford Institute for Human-Centered Artificial Intelligence created an interdisciplinary initiative named the Center for Research on Foundation Models. They coined the term “foundation models” to refer to machine learning models “trained on broad data at scale such that they can be adapted to a wide range of downstream tasks.” Some models considered foundation models include BERT, GPT-4, Codex, and LLaMA. Foundation models are based on artificial neural networks including generative adversarial networks (GANs), transformers, and variational encoders. As adoption and visibility of foundational models has increased, the use of artificial intelligence (AI) and generative AI to refer to the foundation models has become widespread and less discerning.

Contextual grounding techniques have been developed to reduce hallucinations in answers or responses from foundation models and improve accuracy. Grounding is defined as a knowledge of basic facts about a particular subject. In AI, contextual grounding refers to providing knowledge relevant to a query or prompt to AI to ground the response or answer from AI. In terms of a foundation model, contextual grounding refers to providing this relevant knowledge or “context” to the foundation model along with the query or prompt. The context can be added to a query/prompt or the query/prompt can be rewritten to incorporate the context.

### BRIEF DESCRIPTION OF THE DRAWINGS

Embodiments of the disclosure may be better understood by referencing the accompanying drawings.

FIG. 1 is a diagram of a training data generation pipeline that generates a synthetic dataset for training a small language model to check contextual grounding.

FIG. 2 is a flowchart of example operations for generating high quality training data for training a SLM for grounding checking.

FIG. 3 is a flowchart of example operations for checking whether foundation model answers are contextually grounded.

FIG. 4 depicts an example computer system with a data generation pipeline and a lightweight model answer checker.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Terminology

This description uses the terms prompt, response, query, and answer. In the context of language models, prompt and query are used synonymously. Likewise, response and answer are used synonymously. This description uses the pairing of “query” and “answer” when referring to the inputs and outputs for language models for which contextual grounding is being checked. The pairing of “prompt” and “response” is used when referring to the inputs and outputs of models used in the training data generation pipeline and when referring to the small language model that is checking for contextual grounding or consistency with contextual grounding. This use is not to redefine the meanings of the terms, but to aid in explaining the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### Overview

While contextual grounding has reduced hallucinations, they have not eliminated hallucinations by foundation models or “AI.” For instance, foundation models still incorrectly blend together information to produce an incorrect response or answer to a prompt or query. Thus, a lightweight validation or checking system has been created that uses a small language model (SLM) to check foundation model answers. The SLM is trained with a synthetic training dataset created to encompass variations of variables relevant to queries, responses, and contexts. A pipeline generates candidate samples based on random permutations of selections for the training sample variables. Each training sample includes a generated query, a generated context, a generated response, and a label that indicates whether the response is consistent with the generated context (i.e., indicates whether the response is “grounded”) or inconsistent with the generated context (“not grounded”). Multiple foundation models/large language models (LLMs) judge whether the labels are accurate for the training samples. When the judging LLMs agree with a label, the corresponding candidate sample is added to a training dataset. When the judging LLMs disagree or do not completely agree with the label, the corresponding candidate sample is discarded. With the generated training dataset, a SLM can be trained to check an answer from a foundation model and classify the answer as grounded or not grounded. Moreover, the high-quality training dataset produced from the pipeline yields a trained SLM that can evaluate model answers more efficiently and more accurately.

### Example Illustrations

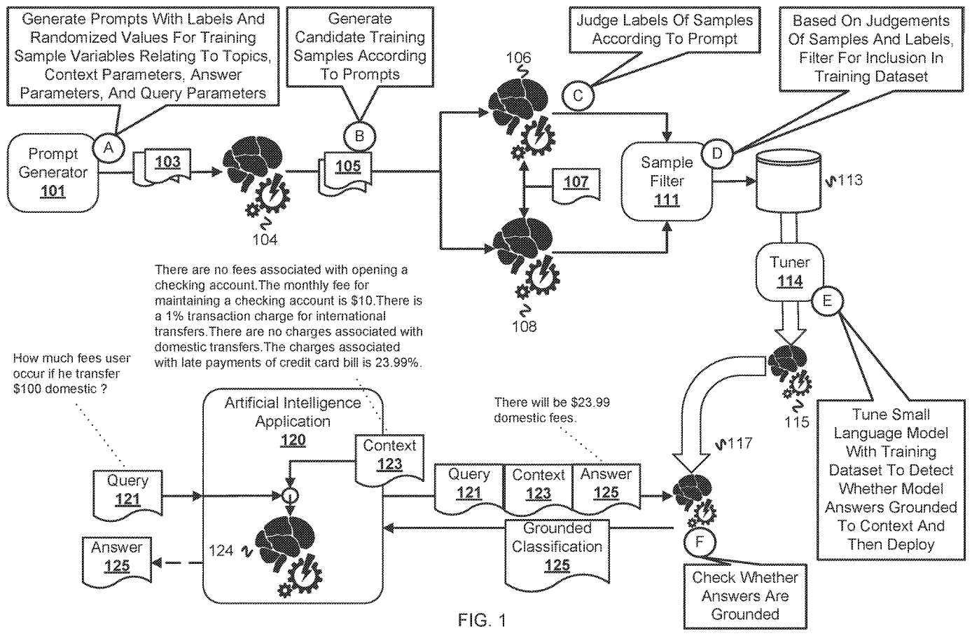

FIG. 1 is a diagram of a training data generation pipeline that generates a synthetic dataset for training a small language model to check contextual grounding. FIG. 1 depicts the training data generation pipeline as including a prompt generator 101, an LLM 104, judging models 106, 108, and a sample filter 111. The judging models 106, 108 are LLMs that vary from each other in an aspect that affects their inference. For instance, the judging models 106, 108 can have different architectures, different pre-training, and/or different configurations. The LLM 104 can be the same type of model as either of the judging models 106, 108.

FIG. 1 is annotated with a series of letters A-F representing stages of operations, each stage corresponding to one or more operations. Although these stages are ordered for this example, the stages illustrate one example to aid in understanding this disclosure and should not be used to limit the claims. For instance, the operations of stage F can overlap with the operations of stages A-E after initial deployment of a trained model. Subject matter falling within the scope of the claims can vary from what is illustrated.

At stage A, the prompt generator 101 generates prompts 103 for the LLM 104. The prompt generator 101 generates each of the prompts 103 with randomized values for training sample variables. The training sample variables relate to topics, context parameters, response parameters, and query parameters. The randomization of the values of these variables yields a high-quality training dataset that encompasses a wide variety of subjects/topics and tasks to facilitate generalizability of the contextual grounding checking. Each generated prompt will task the LLM 104 with generating a query, context, and answer according to the randomized parameter values. Each prompt is associated with a label to be assigned to the training sample that will be generated by the LLM. The label indicates whether the answer generated by the LLM 104 as part of the training sample is grounded with respect to the query and context also generated by the LLM 104. The label is determined by whether the generated prompt specifies that the LLM 104 should generate a grounded answer or an ungrounded answer.

At stage B, the LLM 104 generates candidate training samples 105 according to the prompts 103. The prompts 103 are submitted individually to the LLM 104, at least partly, to reduce the possibility of leakage between training samples and to remain within token limits. Each candidate training sample will include a query, context, answer, and label. Each of the candidate training samples 105 is passed to the judging models 106, 108.

At stage C, the judging models 106, 108 judge the labels of the candidate training samples according to a prompt 107. The prompt 107 can be a system prompt of the judging models 106, 108 associated with the candidate training samples 105 to be judged. The prompt 107 can be constructed based on a template and populated with the candidate training samples 105. If the candidate training samples 105 include reasons or explanations for the generated answers, these are removed before judging to avoid biasing the judging models 106, 108. The prompt 107 will task the judging models 106, 108 with determining whether the label of a candidate training sample is consistent with the corresponding answer, query, and context of the candidate training sample.

At stage D, the sample filter 111 filters the candidate training samples based on the outputs (“judgements”) of the judging models 106, 108. In this example illustration with two judging models, the sample filter 111 filters out those of the candidate training samples 105 for which the judgement by at least one of the judging models 106, 108 is not aligned with the label generated by the LLM 104. If the judgments of both judging models 106, 108 agree with the label for a candidate training sample, then the candidate training sample is included in a repository 113 that hosts a training dataset.

At stage E, a tuner 114 tunes a SLM 115 with the training dataset that has been accumulated in the repository 113. After sufficient samples have been accumulated for training, including testing and validating splits, the tuner 114 initializes training parameters and loads samples of the training dataset selected for training for instruction fine-tuning the SLM 115 to predict whether a training sample is grounded or not grounded. The reasons generated for training samples are used in the training of the SLM. Each of the training samples in the repository 113 may have a reason that was generated by the LLM 104. The reason will be included in the prompts to the SLM during training. After fine-tuning completes, a trained SLM 117 is deployed. Deployment can be installation into a system (e.g., a firewall) or exposing a service that uses the trained SLM 117, for example via application programming interface (API) calls.

At stage F, the trained SLM 117 checks whether answers of a LLM 124 of an AI application 120 are contextually grounded. A query 121 is submitted to the AI application 120. FIG. 1 depicts an example query “How much fees user occur if he transfers $100 domestic?” The AI application 120 retrieves context 123 from an external and/or internal data source. FIG. 1 depicts an example of the context 123 as “There are no fees associated with opening a checking account. The monthly fee for maintaining a checking account is $10. There is a 1% transaction charge for international transfers. There are no charges associated with domestic transfers. The charges associated with late payments of credit card bill is 23.99%.” The AI application 120 submits the query 121 and the context 123 to the LLM 124. The LLM 124 generates an answer 125 to the query 121. FIG. 1 depicts an example of the answer 125 as “There will be $23.99 domestic fees.” The AI application 120 provides the query 121, the context 123, and the answer 125 to the SLM 117. The SLM 117 determines whether the answer 125 is grounded with respect to the context 123 and the query 121. Across various benchmark datasets, a SLM trained with training data generated according to the disclosed training data generation pipeline performs at least as well and often better than a LLM in contextual grounding checking. These benchmark datasets included a COVID dataset, Pubmed dataset, and HaluEval dataset, among others. Inference time measurements of the SLM on these benchmark datasets ranged from 155% to almost 400% faster than a LLM used for grounding checking. The SLM 117 returns a grounded classification 125 to the AI application 120. In the case of the incorrect domestic fees being indicated by the model 124, the grounding classification 125 would indicate that the model answer 125 was not grounded to the context 123 and the query 121 and the answer 125 would not be returned as an answer to the query 121. The AI application 120 can apply a policy or evaluation rule based on the grounded classification 125. For instance, the AI application 120 may collect the answer 125 for later examination, use the feedback grounding checking feedback for model performance evaluation, resubmit the query 121 and context 123 to the LLM 124, etc. If the grounded classification 125 indicates that the answer 125 is grounded, then the AI application 120 can return the answer 125 in response to the query 121.

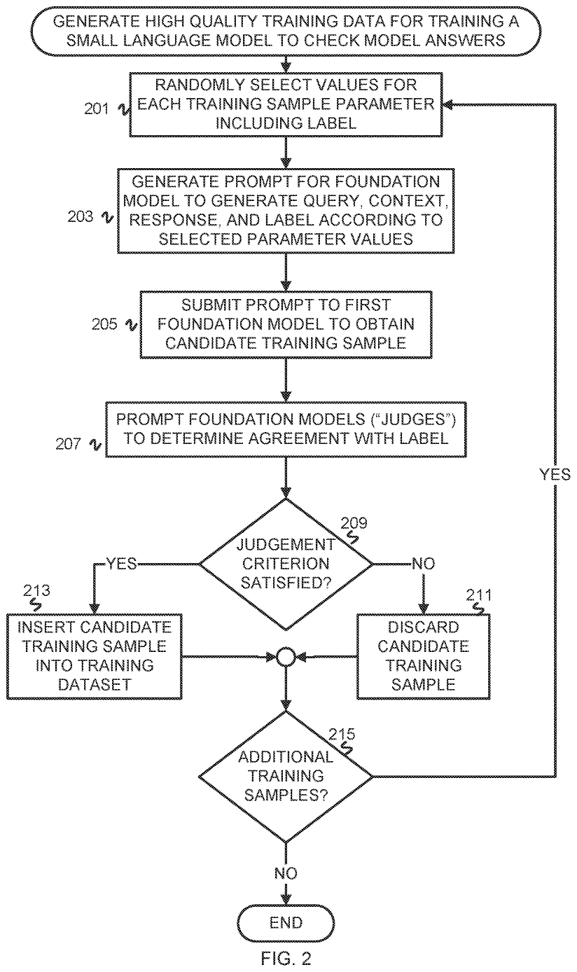

FIG. 2 is a flowchart of example operations for generating high quality training data for training a SLM for grounding checking. As previously mentioned, the checking is determining whether an answer from a language model is grounded based on the corresponding context and query (i.e., determining whether the model answer aligns or is consistent with the query and context). The example operations are described with reference to a training data generation pipeline for consistency with FIG. 1 and ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

At block 201, the training data generation pipeline randomly selects values for each training sample parameter. Parameters that affect both query and answer include topic and task. A comprehensive list of topics is maintained and can be organized according to a taxonomy of topics. Similarly, a list of tasks can be maintained. An example list of tasks includes fact finding, summarizing, concept comparison, identifying pros and cons, defining key concepts, and analyzing effects. In addition, a randomly selected task can be a combination task, such as summarize-and-format or summarize-and-simplify. Functions are defined to randomly select from these lists. Additional parameters include context size and response size. This can be defined with word or token as a metric. A range is defined for each, and a function is defined to select according to the defined ranges. Another parameter to be determined includes whether the answer is to be generated with structure or without structure. If structure is randomly selected, then another function can randomly select from a list of structured answer options, such as table, object format, and bullet points. Embodiments are not limited to selecting a single topic from available topics. Another function can be defined to randomly determine a number of topics within a defined range (e.g., 1-3 topics) and then that number of topics randomly selected. Random selection of values for training parameters also includes randomly selecting whether the answer to be generated should be grounded or not grounded. This randomly selected value is also the basis for a label to be assigned to the training sample generated according to the randomly selected values of the training sample parameters.

At block 203, the training data generation pipeline generates a prompt for a foundation model or LLM to generate a query, context, and response according to selected parameter values. The data generation pipeline can utilize a prompt template that includes the task instructions for the LLM to generate the query, context, and response, as well as placeholders for the randomly selected parameter values. The prompt template can include an explanation of all of the tasks in the list of tasks from which a task was randomly selected. The task instruction for the LLM to generate an answer directs the LLM to generate an answer that is not grounded or inconsistent with either of the query or the context according to the selected grounding training parameter value. The prompt can include a task instruction or constraint that specifies data sources for generating the context in addition to the randomly selected topic. In addition, the prompt template can include a task instruction for the LLM to provide a reason or explanation for the generated answer.

At block 205, the training data generation pipeline submits the prompt to a first foundation model to obtain a candidate training sample. The training data generation pipeline will associate the determined label with the prompt to propagate the label to the obtained candidate training sample.

At block 207, the training data generation pipeline prompts foundation models (“judges”) to determine agreement with a label of the candidate training sample. The training data generation pipeline can prompt the judges with a task instruction to generate their own labels based on the query, context, and answer of the candidate training sample. The data generation pipeline can instead prompt the judges with a task instruction to evaluate the label of the candidate training sample.

At block 209, the training data generation pipeline determines whether a judgement criterion is satisfied. If the judges were tasked with evaluating the labels, then the judgment criterion can be based on whether the responses from the judges indicate agreement or validation of the labels. If the judges were tasked with generating their own labels of whether the answer of a candidate training sample was contextually grounded based on the query and the context of the candidate training sample, then the judgment criterion can be whether the judge generated labels match the label of the candidate training sample. The judgment criterion can also vary depending on implementation of the judges. The judgment criterion can include a condition of unanimous agreement or majority agreement depending on the number of judges. Embodiments can also use judges that vary in domain knowledge (i.e., pre-trained on different datasets) and vary in size. With multiple varying judges, weights can be applied to the judgments from a judge(s) to bias towards larger models and/or models trained on a greater variety of knowledge domains. If the judgment criterion is satisfied, then operational flow proceeds to block 213, and the candidate training sample is inserted into the training sample dataset. Otherwise, operational flow proceeds to block 211, and the candidate training sample is discarded. Operational flow proceeds from block 213 or block 211 to block 215.

At block 215, the training data generation pipeline determines whether additional training samples should be generated. The pipeline can be configured with a threshold number of training samples sufficient for fine-tuning. If additional training samples should be generated, then operational flow returns to block 201. Otherwise, operational flow ends for FIG. 2. However, implementations can continue generating training samples while fine-tuning a SLM.

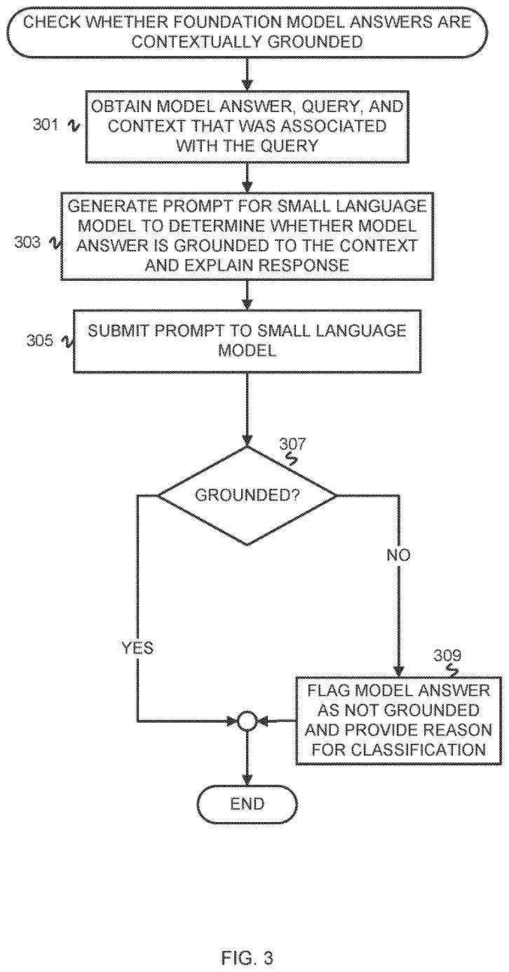

FIG. 3 is a flowchart of example operations for checking whether foundation model answers are contextually grounded. After fine-tuning, a trained SLM can be deployed or made available for evaluating foundation model answers prior to those answers being returned or delivered. The judgement or classification of a foundation model answer as grounded or not grounded from the grounding check can inform an organization's decision on how to handle ungrounded model answers.

At block 301, an interface or wrapper for the SLM obtains a model answer, query, and context that was associated with the query. For instance, an AI application invokes an API call to the SLM for grounding checking and populates the API call with the model answer, query, and context as arguments. In some cases, the SLM is deployed into an environment for grounding checking with more direct access to the query, context, and model answer without delineation as in an API call. In these cases, the grounding checking can pre-process the input to delineate or include in the prompt to the SLM a task instruction to identify in the input the model answer, query, and context.

At block 303, a prompt is generated for the SLM to determine whether the model answer is grounded to the context and query. In addition, the generated prompt includes a task instruction for the SLM to explain its response. The wrapper or interface that obtains the query, context, and answer can include functionality to retrieve a prompt template with these task instructions and populate the prompt template with the query, context, and answer.

At block 305, the generated prompt is submitted to the trained SLM.

At block 307, the trained SLM determines whether the model answer is grounded. If the model answer is not grounded, then operational flow proceeds to block 309. If the model answer is grounded, the operational flow of FIG. 3 ends.

At block 309, the trained SLM flags the model answer as not grounded. Flagging the model answer can be associating the not grounded judgment/classification with the model answer and returning the flagged model answer.

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, that employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

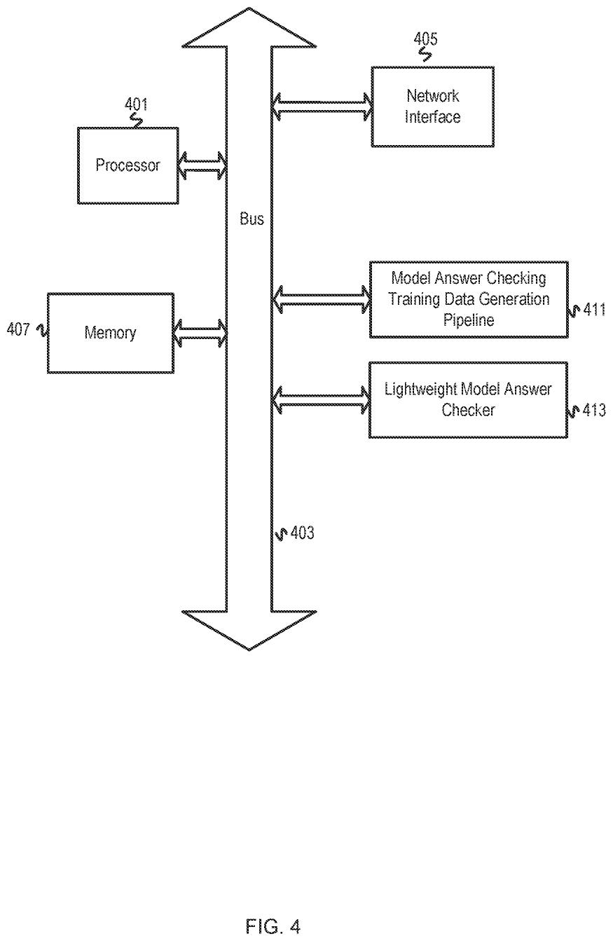

FIG. 4 depicts an example computer system with a data generation pipeline and a lightweight model answer checker. The computer system includes a processor 401 (possibly including multiple processors, multiple cores, multiple nodes, and/or implementing multi-threading, etc.). The computer system includes memory 407. The memory 407 may be system memory or any one or more of the above already described possible realizations of machine-readable media. The computer system also includes a bus 403 and a network interface 405. The system also includes a model answer checking training data generation pipeline 411 (“data generation pipeline”) and a lightweight model answer checker 413 (“lightweight checker”). The data generation pipeline 411 generates synthetic candidate training samples for various permutations of topic, task, query size, answer size, structure, etc. along with checking labels for the generated answers. The data generation pipeline 411 uses randomizers or randomization functions to randomly select values for these parameters in order to produce a high-quality training dataset that spreads across numerous domains of knowledge and tasks for fine-tuning a small foundation model (e.g., a foundation model with fewer parameters than a LLM) for grounding checking of foundation model answers. The data generation pipeline 411 uses the capabilities of larger foundation models despite the longer inference time to produce the training samples and uses the larger foundation model capabilities of different types to evaluate the labels generated for the candidate training samples. The data generation pipeline 411 then discards those of the candidate training samples that do not align with the judgments of the larger foundation models that are evaluating the labels of the candidate training samples. The training dataset is then used to fine-tune a small or mini foundation model to create and persist the lightweight checker 413. Any one of the previously described functionalities may be partially (or entirely) implemented in hardware and/or on the processor 401. For example, the functionality may be implemented with an application specific integrated circuit, in logic implemented in the processor 401, in a co-processor on a peripheral device or card, etc. Further, realizations may include fewer or additional components not illustrated in FIG. 4 (e.g., video cards, audio cards, additional network interfaces, peripheral devices, etc.). The processor 401 and the network interface 405 are coupled to the bus 403. Although illustrated as being coupled to the bus 403, the memory 407 may be coupled to the processor 401.

1. A method comprising:
generating candidate training data samples for fine-tuning a small language model to check grounding of foundation model answers, wherein generating each of the candidate training data samples comprises,
randomly selecting values of parameters corresponding to generation of a candidate training sample comprising a query, context, an answer to the query;
generating a prompt with task instructions for a first foundation model to generate a query and context based on a first subset of the selected parameter values and an answer to the query based on a second subset of the selected parameter values, and
determining a label for the candidate training sample to be generated by the first foundation model, wherein the label is based on whether the prompt tasks the foundation model to generate a grounded answer or an answer that is not grounded;
submitting the prompt to a first foundation model to obtain the candidate training data sample;
prompting each of a plurality of second foundation models to determine, for each candidate training sample, whether the answer of the candidate training sample is grounded to the query and the context of the candidate training sample; and
for each candidate training sample, determining whether to include the candidate training data sample in a training dataset for fine-tuning a small language model based on agreement between the label of the candidate training sample and the responses from the plurality of second foundation models for the candidate training sample.

2. The method of claim 1 further comprising fine-tuning a small language model for grounding checking with the training dataset.

3. The method of claim 1, wherein generating each prompt with task instructions for a first foundation model to generate an answer to the query based on a second subset of the selected parameter values comprises generating the prompt with a task instruction for the first foundation model to generate a grounded answer or a task instruction for the first foundation model to generate an answer not grounded to the query and the context, wherein randomly selecting values of parameters comprises randomly selecting between not grounded and grounded.

4. The method of claim 1, wherein the parameters comprise topic, task, grounded or not grounded answer.

5. The method of claim 4, wherein the parameters further comprise at least one of format, query size, context size, and answer size.

6. The method of claim 1, wherein generating each prompt further comprises generating each prompt with a task instruction for the first foundation model to provide an explanation or reason for an answer to a query.

7. The method of claim 1, wherein the plurality of second foundation models vary in at least one of model type and pre-training.

8. The method of claim 1, wherein determining whether to include each candidate training data sample in the training dataset comprises, for each candidate training sample:
determining whether the label for the candidate training sample is consistent with outputs of the plurality of second foundation models for the candidate training sample;
based on determining that the label for the candidate training sample is consistent with outputs of the plurality of second foundation models for the candidate training sample, inserting the candidate training data sample into the training dataset; and
based on determining that the label for the candidate training sample is not consistent with outputs of the plurality of second foundation models for the candidate training sample, discarding the candidate training data sample.

9. The method of claim 1, wherein generating candidate training data samples comprises generating candidate training data samples until a threshold number of candidate training data samples have been included in the training dataset.

10. A non-transitory machine-readable medium having stored thereon a program code comprising instructions to:
generate a plurality of prompts for a first large language model (LLM) to generate candidate training samples that comprise queries, context, and answers,
wherein the instructions to generate the plurality of prompts comprise instructions to, for each prompt,
randomly select values for parameters at least corresponding to topic, whether a generated answer should be grounded or not grounded, and task;
construct the prompt based, at least in part, on the randomly selected values;
determine a label to be associated with a candidate training sample generated in response to the prompt, wherein the label is based on the value that was randomly selected for the parameter corresponding to whether the answer to be generated based on the prompt is grounded or not grounded;
submit the plurality of prompts to the first LLM to obtain a plurality of candidate training samples;
prompt a plurality of second LLMs to indicate, for each of the plurality of candidate training samples, whether the answer of the candidate training sample is grounded to the query and the context of the candidate training sample; and
include a subset of the plurality of candidate training samples into a training dataset for a small language model based on agreement of responses from the plurality of second LLMs and the labels.

11. The non-transitory machine-readable medium of claim 10, wherein the program code further comprises instructions to train a small language model for grounding checking with the training dataset.

12. The non-transitory machine-readable medium of claim 11, wherein the instructions to construct each prompt comprise instructions to construct each prompt with a task instruction to generate a reason for an answer, wherein the instructions to train the small language model comprise instructions to uses the reasons generated for the subset of candidate training samples during training.

13. The non-transitory machine-readable medium of claim 10, wherein the parameters also correspond to size of the context and size of the response.

14. The non-transitory machine-readable medium of claim 10, wherein the instructions to construct each prompt comprise instructions to construct each prompt based on a prompt template that includes an explanation of each possible task that could be specified in the prompt and to construct the prompt with a task instruction to generate a query according to the randomly selected task and the randomly selected topic and to generate an answer accordingly to the randomly selected value of grounded or not grounded.

15. The non-transitory machine-readable medium of claim 10, wherein the instructions to include a subset of the plurality of candidate training samples into a training dataset for a small language model based on agreement of responses from the plurality of second LLMs and the labels comprise instructions to, for each candidate training sample, determine whether the label determined for the candidate training sample matches at least a majority of the responses from the second plurality of LLMs for the candidate training sample.

16. An apparatus comprising:
a processor; and
a machine-readable medium having stored thereon instructions executable by the processor to cause the apparatus to,
generate a plurality of prompts for a first large language model (LLM) to generate candidate training samples that comprise queries, context, and answers,
wherein the instructions to generate the plurality of prompts comprise instructions to, for each prompt,
randomly select values for parameters at least corresponding to topic, whether a generated answer should be grounded or not grounded, and task;
construct the prompt based, at least in part, on the randomly selected values;
determine a label to be associated with a candidate training sample generated in response to the prompt, wherein the label is based on the value that was randomly selected for the parameter corresponding to whether the answer to be generated based on the prompt is grounded or not grounded;
submit the plurality of prompts to the first LLM to obtain a plurality of candidate training samples;
prompt a plurality of second LLMs to indicate, for each of the plurality of candidate training samples, whether the answer of the candidate training sample is grounded to the query and the context of the candidate training sample; and
include a subset of the plurality of candidate training samples into a training dataset for a small language model based on agreement of responses from the plurality of second LLMs and the labels.

17. The apparatus of claim 16, wherein the machine-readable medium further has stored thereon instructions executable by the processor to cause the apparatus to train a small language model for grounding checking with the training dataset.

18. The apparatus of claim 17, wherein the instructions to construct each prompt comprise instructions executable by the processor to cause the apparatus to construct each prompt with a task instruction to generate a reason for an answer, wherein the instructions to train the small language model comprise instructions to uses the reasons generated for the subset of candidate training samples during training.

19. The apparatus of claim 16, wherein the parameters also correspond to size of the context and size of the response.

20. The apparatus of claim 16, wherein the instructions to construct each prompt comprise instructions executable by the processor to cause the apparatus to construct each prompt based on a prompt template that includes an explanation of each possible task that could be specified in the prompt and to construct the prompt with a task instruction to generate a query according to the randomly selected task and the randomly selected topic and to generate an answer accordingly to the randomly selected grounded or not grounded value.

21. The apparatus of claim 16, wherein the instructions to include a subset of the plurality of candidate training samples into a training dataset for a small language model based on agreement of responses from the plurality of second LLMs and the labels comprise instructions executable by the processor to cause the apparatus to, for each candidate training sample, determine whether the label determined for the candidate training sample matches at least a majority of the responses from the second plurality of LLMs for the candidate training sample.
